(19) United States
(12) Patent Application Publication
(10) Pub. No.: US 2015/0060373 A1
(43) Pub. Date: Mar. 5, 2015

(54) MAKEUP BRUSH HOLDER

(71) Applicant: BOA SHENG CORPORATION, Anyang-si (KR)

(72) Inventor: Mi Yeon BYEON, Anyang-si (KR)

(73) Assignee: BOA SHENG CORPORATION, Anyang-si (KR)

(21) Appl. No.: 14/035,274

(22) Filed: Sep. 24, 2013

(30) Foreign Application Priority Data
Aug. 30, 2013 (KR) 20-2013-0007293

(51) Int. Cl. A46B 17/02; A47F 5/00; F16B 2/00

(52) U.S. Cl. CPC A46B 17/02; F16B 2/00; A47F 5/0006; A46B 2200/1046
USPC 211/1.3; 211/65

(57) ABSTRACT

Disclosed herein is a makeup brush holder for holding a makeup brush having a rod-shaped body and bristles provided on the rod-shaped body. The makeup brush holder includes a holding plate, a holding part which is provided in the holding plate to hold the rod-shaped body, and a plate support which supports the holding plate at a predetermined location. The holding part has a seating hole which is formed through the holding plate, and an elastic holding film which is provided in the seating hole. Slits are formed in a central portion of the holding film so that the rod-shaped body can be inserted into the holding film. When the rod-shaped body is inserted into the seating hole through the slits, the rod-shaped body is held in the holding part by a restoring force of the holding film and a frictional force between the holding film and the rod-shaped body.

### BACKGROUND OF THE INVENTION

1. Field of the Invention

The present invention relates generally to makeup brush holders and, more particularly, to a makeup brush holder which can hold a plurality of makeup brushes and facilitates a process of supporting the makeup brushes on the makeup brush holder or removing them therefrom, thus providing convenience to a user, and which has a simple holding structure, whereby the makeup brush holder can be prevented from being damaged by malfunction thereof, and there is no possibility of a reduction in the durability of the makeup brush holder after repetitive use, so that the makeup brush can be used semi-permanently.

2. Description of the Related Art

Makeup brushes are tools which are used to apply makeup powder or liquid to the skin of users. Typically, the makeup brushes are configured such that bristles made of animal hair are attached to an end of a plastic or wooden rod which functions as a handle.

Such a makeup brush is used in such a way a user holds the handle, immerses bristles in a makeup container to apply makeup power or liquid to the bristles, and then applies it to the cheeks or eyes.

Because bristles of makeup brushes come into direct contact with the skin of users, the bristles are preferably made of a material which is soft and to which makeup powder or liquid can be easily applied. For example, animal hair such as goat hair or horse hair may be used as bristles of makeup brushes.

Such makeup brushes use different kinds of bristles having various lengths and bristle thicknesses depending on the purpose of the use. Therefore, not only makeup artists but also general users typically have different kinds of makeup brushes.

In the case of makeup brushes, storage thereof as well as usage thereof is very crucial. Unless the makeup brushes are stored or dried in such a way that bristles face downward toward the ground, the bristles may be bent or spread out. If so, the makeup brushes may not be rendered unusable.

Moreover, recently, the number of users who wash makeup brushes and dry them before using them again is increasing.

That is, if a makeup brush is used for a long period of time, nutritional contents that have been contained in makeup powder or liquid remain in the makeup brush, thus causing the propagation of colon bacillus or other germs which may induce inflammation on the skin of a user. Particularly, if germs pass through the skin through an injured portion, secondary infection may be caused.

Despite various needs, for example, storage of makeup brushes or drying thereof after washing, there is no makeup brush holder which can meet these needs.

### PRIOR ART DOCUMENT

### Patent document

(Patent document 0001) KR Utility Model Registration No. 20-0427903

### SUMMARY OF THE INVENTION

Accordingly, the present invention has been made keeping in mind the above problems occurring in the prior art, and an object of the present invention is to provide a makeup brush holder which is configured such that a makeup brush can be easily held by the makeup brush holder merely by the simple motion of inserting the body of the makeup brush into a holding film of the makeup brush holder and can be easily removed from the makeup brush holder by simple motion of pulling it therefrom, thus providing convenience to a user.

Another object of the present invention is to provide a makeup brush holder in which the structure for holding the makeup brush does not require a separate mechanical coupling or mechanical connection process, whereby the makeup brush holder can be prevented from being damaged by malfunction thereof, and there is no possibility of a reduction in the durability of the makeup brush holder after repetitive use, so that the makeup brush can be used semi-permanently.

A further object of the present invention is to provide a makeup brush holder which has a simple bar structure so that even when holding parts having various sizes and shapes are formed in a holding plate, the production cost can be minimized.

In order to accomplish the above object, the present invention provides a makeup brush holder for holding a makeup brush having a rod-shaped body and bristles provided on an end of the rod-shaped body, the makeup brush holder including: a holding plate; a holding part provided in the holding plate to hold a portion of the rod-shaped body; and a plate support supporting the holding plate at a predetermined location, wherein the holding part has: a seating hole formed through the holding plate, the seating hole having a circular or polygonal shape, and a holding film provided in the seating hole, the holding film being made of elastic material, with a plurality of slits formed in a central portion of the holding film so that the rod-shaped body can be inserted into the holding film, and when the rod-shaped body is inserted into the seating hole and disposed in the holding film through the slits, the rod-shaped body is caught in the holding part by a restoring force of the holding film and a frictional force between the holding film and the rod-shaped body.

The seating hole may comprise a plurality of seating holes formed in the holing plate. The seating holes may have different sizes in response to a variety of sizes of a cross-section of the rod-shaped body.

The holding film may have a through hole formed in a central portion of the holding film, and three or four slits formed around the through hole.

The holding plate may comprise two or more holding plates. The makeup brush holder may further include a central body to which an end of each of the holding plates is rotatably coupled, wherein when the makeup brush holder is in a use state in which the makeup brush is held by the makeup brush holder, the holding plates are radially deployed around the central body to allow the makeup brush to be held by one of the holding plates, and when the makeup brush holder is in a folded state, the holding plates are rotated upwards and gathered together.

The plate support may include a hanging part extending upwards from the central body. The hanging part may be bent in a hanger shape so that the hanging part can be hung on a rod or hook installed on a support surface.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a makeup brush holder, according to an embodiment of the present invention;

FIG. 2 is an enlarged view illustrating brush holding operation of the makeup brush holder of the present invention;

FIG. 3 is a photograph showing a folded state of the makeup brush holder according to the embodiment of the present invention;

FIG. 4 is a photograph showing a usage example of the makeup brush holder according to the embodiment of the present invention; and

FIG. 5 is a perspective view illustrating a makeup brush holder, according to another embodiment of the present invention.

### DESCRIPTION OF THE PREFERRED EMBODIMENTS

Hereinafter, the present invention will be described in detail with reference to the attached drawings.

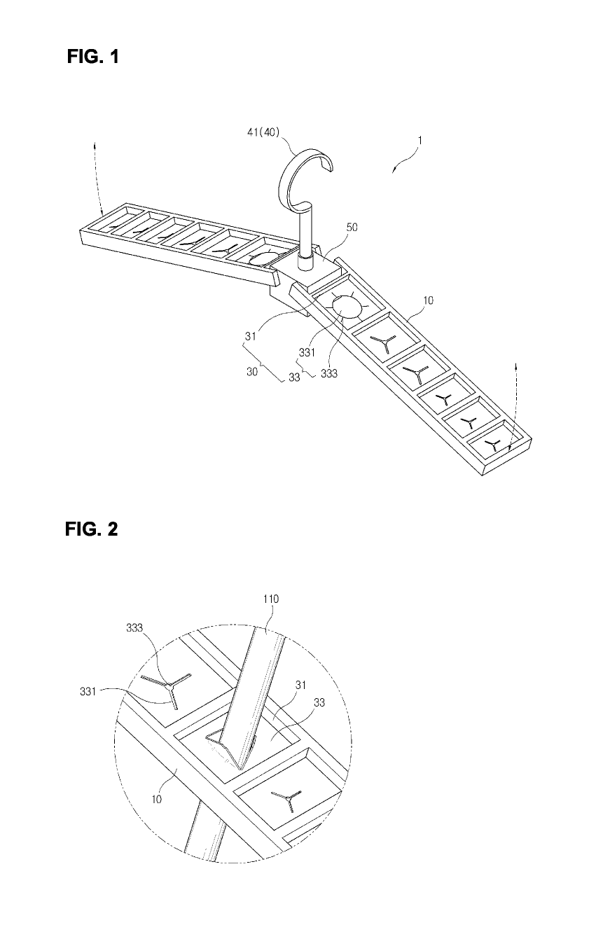

Referring to FIG. 1, a makeup brush holder 1 according to an embodiment of the present invention functions to hold makeup brushes 100, each of which includes a rod-shaped body 110 and bristles 120 provided on an end of the rod-shaped body 110. The makeup brush holder 1 includes a holding plate 10, a holding part 30 which holds a portion of the rod-shaped body 110, and a plate support 40 which supports the holding plate 10 at a predetermined location. The holding part 30 has a seating hole 31 and a holding film 33. The rod-shaped body 110 is disposed in the seating hole 31 and is held by the holding film 33.

As shown in FIG. 4, each makeup brush 100 includes the rod-shaped body 110 and the bristles 120 provided on an end of the rod-shaped body 110.

The rod-shaped body 110 has a size and volume corresponding to those of the bristles 120. The cross-section of the rod-shaped body 110 can have a variety of shapes, for example, a circular shape, an elliptical shape, a polygonal shape, etc.

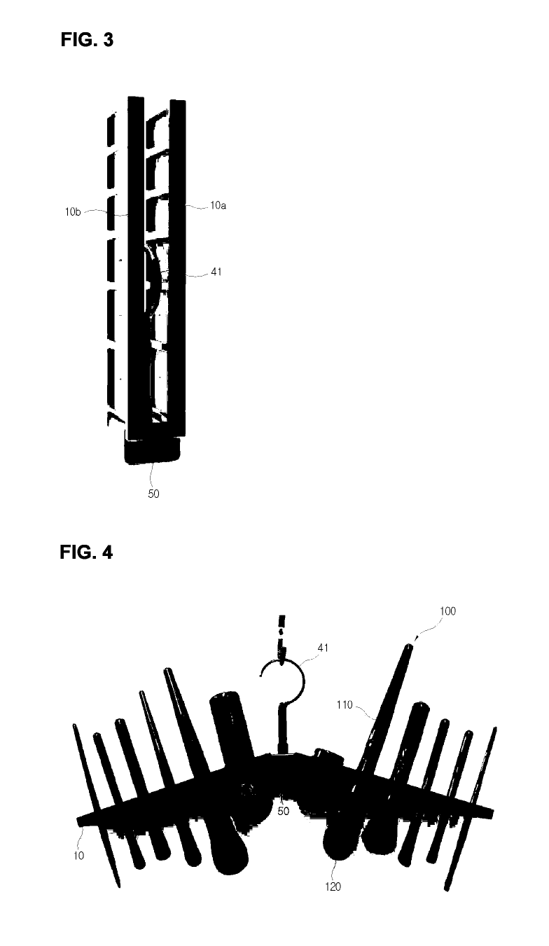

The holding plate 10 preferably has a planar shape and can be formed in a variety of sizes and shapes. As needed, the holding plate 10 may comprise a plurality of holding plates 10, in other words, two or more holding plates 10a and 10b, as shown in FIG. 3.

The holding part 30 is provided in the holding plate 10, and a portion of the rod-shaped body 110 is held by the holding part 30.

The holding part 30 has the seating hole 31 and the holding film 33.

The seating hole 31 is formed through the holding plate 10 and can have a variety of shapes for example a circular shape, an elliptical shape, a polygonal shape, etc.

As needed, the number of seating holes 31 may be modified in a variety of ways. For example, only one seating hole 31 may be formed or, alternatively, as shown in FIG. 1, a plurality of seating holes 31 may be formed.

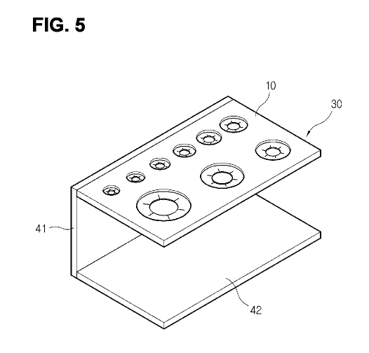

If a plurality of seating holes 31 are formed, arrangement of the seating holes 31 is not limited to a special method. That is, as shown in FIG. 1, the seating holes 31 may be arranged in a row. Alternatively, as shown in FIG. 5, the seating holes 31 may be arranged in two rows. In addition to these, the seating holes 31 can be formed in a variety of arrangements.

Furthermore, each seating hole 31 can have a variety of shapes. For example, as shown in FIG. 1, the seating hole 31 may have a rectangular shape. Alternatively, as shown in FIG. 5, the seating hole 31 may have a circular shape.

The seating holes 31 may have the same size. Alternatively, as shown in FIGS. 1 and 5, the seating holes 31 may have a variety of sizes in response to the sizes of the rod-shaped bodies 110 of the makeup brushes.

The holding film 33 is provided in the seating hole 31. A plurality of slits 331 are formed to allow the rod-shaped body 110 of the makeup brush to be inserted into the holding film 33.

The holding film 33 is a soft film made of material such as natural rubber, synthetic rubber or synthetic resin, having appropriate elasticity.

The several slits 331 are formed in a central portion of the holding film 33 so that the rod-shaped body 110 can be inserted into the holing film 33.

To hold the makeup brush 100 using the makeup brush holder 1, as shown in FIG. 2, the rod-shaped body 110 of the makeup brush 100 is inserted into the holding film 33 through the slits 331. Then, the rod-shaped body 110 is held in the holding part 30 by the restoring force of the holding film 33 and the frictional force between the holding film 33 and the rod-shaped body 110.

To remove the makeup brush 100 from the makeup brush holder 1, there is only a need for pulling the makeup brush 100 with force greater than the restoring force and frictional force of the holding film 33.

As such, the makeup brush 100 can be easily held by the makeup brush holder 1 or removed therefrom by simple motion of inserting the rod-shaped body of the makeup brush 100 into the holding film or pulling it therefrom. Therefore, the present invention is more convenient for the user.

Furthermore, the structure for holding the makeup brush 100 does not require a separate mechanical coupling or mechanical connection process, whereby the makeup brush holder 1 can be prevented from being damaged by malfunction thereof, and there is no possibility of a reduction in the durability of the makeup brush holder 1 after repetitive use. As a result, the makeup brush 100 of the present invention can be used semi-permanently.

In addition, the present invention has a simple bar structure. Therefore, even when holding parts 30 having various sizes and shapes are formed in the holding plate 10, the production cost can be minimized.

As shown in FIG. 1, the several slits 331 are formed in the holding film 33 around the central portion of the holding film 33. For example, it is preferable that the slits 331 be arranged in radial directions.

The number of slits 331 and the length of each slit 331 can be changed in a variety of ways depending on the sizes of the cross-sections of the rod-shaped bodies 110 of makeup brushes to be held by the makeup brush holder 1. For example, as shown in FIG. 1, if the size of the cross-section of the rod-shaped body 110 is comparatively small, it is preferable that the length of each slit 331 be relatively short. If the size of the cross-section of the rod-shaped body 110 is comparatively large, it is preferable that the length of each slit 331 be relatively long, and the width of the slit 331 may be increased.

In this embodiment, a through hole 333 is formed in the central portion of the holding film 33 so as to facilitate insertion of the rod-shaped body 110 into the holding film 33. Also, the through hole 333 prevents cut parts of the holding film 33 from making contact with each other, thus preventing the holding film 33 from being deformed.

The through hole 333 can have a variety of sizes depending on the sizes of the cross-sections of the rod-shaped bodies 110 of makeup brushes to be held by the makeup brush holder 1. If the size of the cross-section of the rod-shaped body 110 is comparatively large, the lengths of the slits 331 are also increased in proportion to the size of the cross-section of the rod-shaped body 110. In the case where the lengths of the slits 331 are excessively long, when the rod-shaped body 110 of the makeup brush is inserted into the holding film 33, the lengths of the cut parts of the holding film 33 that are bent by the rod-shaped body 110 are excessively increased, thus deteriorating the general appearance of the makeup brush holder, and reducing the restoring force of the holding film 33. Given this, it is preferable that the through hole 333 be formed in the holding film 33 in an appropriate size corresponding to that of the rod-shaped body 110.

The plate support 40 is provided to support the holding plate 10 at a desired location.

The desired location at which the holding plate 10 is supported may be on a ground surface on which the makeup brush holder 1 is installed or be defined by a string or rod on which the makeup brush holder 1 is suspended. Alternatively, as shown in FIG. 4, the desired location may be defined by a hook which is provided on a wall.

In the former case, as shown in FIG. 5, the plate support 40 may be configured to have a structure appropriate to place it on the ground surface. Moreover, the makeup brush holder 1 may be configured such that it is folded, thus increasing its convenience in use. That is, a first plate support 41 is rotated towards the holding plate 10 by a hinge and thus folded thereonto, and a second plate support 42 is rotated by a hinge in a direction opposite to the direction in which the first plate support 41 is rotated and thus folded onto the holding plate 10.

The latter case will be explained in detail with reference to FIGS. 1 through 4.

The holding plate 10 may comprise two or more holding plates 10. Although, in FIG. 1, the two holding plates 10 have been illustrated as being provided, three or more holding plates 10 may be provided. In this case, for example, the holding plates 10 are radially arranged around a central body in the same shape in which umbrella ribs are radially arranged around an umbrella tube (FIG. 4 illustrates a usage example of the makeup brush holder).

Each holding plate 10 may be coupled to the central body 50 so as to be rotatable upwards or downwards. In this case, as shown in FIG. 3, when the holding plates 10 are folded upwards, the makeup brush holder 1 enters a folded state, thus minimizing the volume of the makeup brush holder 1, thereby facilitating the storage thereof.

In this case, as shown in FIGS. 1 and 4, the plate support 40 extends upwards from the central body 50 and is bent in a shape similar to that of a hanger, thus forming a hanging part 45 which can be removably hung on a support rod or hook.

As described above, in a makeup brush holder according to the present invention, a makeup brush can easily held by the makeup brush holder merely by the simple motion of inserting the body of the makeup brush into a holding film of the makeup brush holder and can be easily removed from the makeup brush holder by the simple motion of pulling it therefrom. Therefore, the present invention is more convenient for the user.

Furthermore, the structure for holding the makeup brush does not require a separate mechanical coupling or mechanical connection process, whereby the makeup brush holder can be prevented from being damaged by malfunction thereof, and there is no possibility of a reduction in the durability of the makeup brush holder after repetitive use. As a result, the makeup brush of the present invention can be used semi-permanently. permanently.

In addition, the present invention has a simple bar structure. Therefore, even when holding parts having various sizes and shapes are formed in the holding plate, the production cost can be minimized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A makeup brush holder for holding a makeup brush having a rod-shaped body and bristles provided on an end of the rod-shaped body, the makeup brush holder comprising:
a holding plate;
a holding part provided in the holding plate to hold a portion of the rod-shaped body; and
a plate support supporting the holding plate at a predetermined location,
wherein the holding part has: a seating hole formed through the holding plate, the seating hole having a circular or polygonal shape, and a holding film provided in the seating hole, the holding film being made of elastic material, with a plurality of slits formed in a central portion of the holding film so that the rod-shaped body can be inserted into the holding film, and
when the rod-shaped body is inserted into the seating hole and disposed in the holding film through the slits, the rod-shaped body is caught in the holding part by a restoring force of the holding film and a frictional force between the holding film and the rod-shaped body.

2. The makeup brush holder as set forth in claim 1, wherein the seating hole comprises a plurality of seating holes formed in the holing plate, the seating holes having different sizes in response to a variety of sizes of a cross-section of the rod-shaped body.

3. The makeup brush holder as set forth in claim 1, wherein the holding film has a through hole formed in a central portion of the holding film, and three or four slits formed around the through hole.

4. The makeup brush holder as set forth in claim 1, wherein the holding plate comprises two or more holding plates, the makeup brush holder further comprising
a central body to which an end of each of the holding plates is rotatably coupled,
wherein when the makeup brush holder is in a use state in which the makeup brush is held by the makeup brush holder, the holding plates are radially deployed around the central body to allow the makeup brush to be held by one of the holding plates, and when the makeup brush holder is in a folded state, the holding plates are rotated upwards and gathered together.

5. The makeup brush holder as set forth in claim 4, wherein the plate support comprises a hanging part extending upwards from the central body, the hanging part being bent in a hanger shape so that the hanging part can be hung on a rod or hook installed on a support surface.

6. The makeup brush holder as set forth in claim 2, wherein the holding plate comprises two or more holding plates, the makeup brush holder further comprising
a central body to which an end of each of the holding plates is rotatably coupled,
wherein when the makeup brush holder is in a use state in which the makeup brush is held by the makeup brush holder, the holding plates are radially deployed around the central body to allow the makeup brush to be held by one of the holding plates, and when the makeup brush holder is in a folded state, the holding plates are rotated upwards and gathered together.

7. The makeup brush holder as set forth in claim 3, wherein the holding plate comprises two or more holding plates, the makeup brush holder further comprising
a central body to which an end of each of the holding plates is rotatably coupled,
wherein when the makeup brush holder is in a use state in which the makeup brush is held by the makeup brush holder, the holding plates are radially deployed around the central body to allow the makeup brush to be held by one of the holding plates, and when the makeup brush holder is in a folded state, the holding plates are rotated upwards and gathered together.
